(19) United States
(12) Patent Application Publication
(10) Pub. No.: US 2008/0037867 A1
(43) Pub. Date: Feb. 14, 2008

(54) Image display device and image display method supporting power control of multicolor light source

(75) Inventors: Seung-sin Lee, Yongin-si (KR); In-ji Kim, Yongin-si (KR); Won-hee Choe, Gyeongju-si (KR); Du-sik Park, Suwon-si (KR)

Correspondence Address: STAAS & HALSEY LLP, SUITE 700, 1201 NEW YORK AVENUE, N.W., WASHINGTON, DC, 20005, US

(73) Assignee: Samsung Electro-Mechanics Co., Ltd., Suwon-si (KR)

(21) Appl. No.: 11/878,782

(22) Filed: Jul. 26, 2007

(30) Foreign Application Priority Data
Aug. 10, 2006 (KR) 10-2006-0075839

(51) Int. Cl. G06K 9/00

(52) U.S. Cl. 382/168

(57) ABSTRACT

Provided is an image display device, more particularly, an apparatus and method that can reduce power consumption and prevent image characteristics from being degraded in an image display device using a multicolor light source. The image display device includes a histogram analysis unit calculating a parameter representative of an input image on the basis of a histogram of the input image, a model selection unit analyzing the parameter and selecting a representative model including the input image among a plurality of representative models, a luminance reduction amount calculation unit calculating a luminance reduction amount for each color light source of the input image on the basis of a maximum luminance reduction rate corresponding to the selected model, a power reduction amount calculation unit calculating a power reduction amount for each color light source according to the luminance reduction amount on the basis of a power characteristic of each color light source, and a power control unit supplying power reduced by the power reduction amount to each color light source.

### CROSS REFERENCE TO RELATED APPLICATION

This application claims priority from Korean Patent Application No. 10-2006-0075839 filed on Aug. 10, 2006 in the Korean Intellectual Property Office, the disclosure of which is incorporated herein by reference in its entirety.

### BACKGROUND OF THE INVENTION

1. Field of the Invention

The present invention relates to an image display device, and more particularly, to an apparatus and method that can reduce power consumption and prevent image characteristics from being degraded in an image display device using a multicolor light source.

2. Description of the Related Art

An image display device supplies information including various contents, such as still pictures, moving pictures, sound, and the like, to a user, in addition to simple text information. Particularly, since the moving pictures among various kinds of multimedia information becomes the base of the next generation VOD (Video-on-Demand) service or interactive service, studies for associated standard have been actively performed.

With the development of digital electronics technologies, analog data are being digitalized, and many digital image data processing technologies that can enable efficient processing of a great volume of data have been proposed. The digital image data processing technologies have the following advantages.

First, when an analog image processing apparatus processes an analog signal, unnecessary noise is inevitably generated. Therefore, it is difficult to prevent quality of the analog signal processed by the analog image processing apparatus from being degraded. However, when the digital image processing apparatus processes image data, quality degradation does not occur.

Second, since signals are processed after being digitalized, a computer can be used to process the signals. That is, since the computer processes image signals, it is possible to perform various kinds of image processing, such as compression of image information and the like.

These days, an RGB color model is used for most of digital image signal display devices, such as an LCD (Liquid Crystal Display), a PDP (Plasma Display Panel), an OLED (Organic Light Emitting Diodes), and the like.

A color model (or color space) is a method of displaying a relationship between one color and other colors. A plurality of image processing systems use different color models due to various reasons. The RGB color space includes three primary colors that can be added to each other, such as red (hereinafter, referred to as “R”), green (hereinafter, referred to as “G”), and blue (hereinafter, referred to as “B”). The spectral elements of these colors are mixed so as to display a color.

The RGB model is displayed by a three-dimensional cube, in which edges of individual axes represent red, green, and blue, respectively. Black is located at an origin and white is located at an opposing end of the cube to the origin. For example, red is represented as (255, 0, 0) in a 24-bit color graphic system having 8 bits per color channel.

Design of a computer graphic system may be simple with the RGB model. However, the RGB model is not ideal to all applications. It is because the color elements, such as red, green, and blue, have significant correlation. A plurality of image processing technologies, such as histogram smoothness or the like, may be performed using only brightness elements. Accordingly, an RGB image should be frequently converted to a brightness image. In order to convert an image from an RGB color into a brightness level, a value obtained by multiplying each element by ⅓ and then adding the element values, that is, an average is used. However, Equation 1 may be used on the basis of the NTSC (National Television Systems Committee) standard.

Y=0.288R+0.587G+0.114B [Equation 1]

Power consumption in a display module that displays an image using an image display device based on RGB sub pixels forms a comparatively greater part of power consumption in an entire image display device.

However, if luminance of a light source is lowered so as to reduce power consumption in the display module, there is a problem in that visibility of the image to be displayed through the display module is degraded. Accordingly, a method that can reduce power consumption of the image display device without degrading visibility of the image is demanded.

Various methods (for example, see Korean Patent Publication Application No. 2002-032018 entitled “liquid crystal display capable of increasing adaptive luminance, and apparatus and method of driving the same”) have been suggested, but the above-described problems still remain unsolved.

### SUMMARY OF THE INVENTION

An object of the invention is to provide an image display device that uses multicolor light source, more particularly, an image display device and an image display method that can reduce power consumption and prevent degradation of an image characteristic due to reduction in power consumption.

Objects of the invention are not limited to those mentioned above, and other objects of the invention will be apparently understood by those skilled in the art through the following description.

According to an aspect of the present invention, there is provided an image display device that includes a histogram analysis unit calculating a parameter representative of an input image on the basis of a histogram of the input image, a model selection unit analyzing the parameter and selects a representative model including the input image among a plurality of representative models, a luminance reduction amount calculation unit calculating a luminance reduction amount for each color light source of the input image on the basis of a maximum luminance reduction rate corresponding to the selected model, a power reduction amount calculation unit calculating a power reduction amount for each color light source according to the luminance reduction amount on the basis of a power characteristic of each color light source, and a power control unit supplying power reduced by the power reduction amount to each color light source.

According to another aspect of the present invention, there is provided an image display method that includes calculating a parameter representative of an input image on the basis of a histogram of the input image, analyzing the parameter and selecting a representative model including the input image among a plurality of representative models, calculating a luminance reduction amount for each color light source of the input image on the basis of a maximum luminance reduction rate, calculating a power reduction amount for each color light source on the basis of the luminance reduction amount on the basis of power characteristic of each color light source, and supplying power reduced by the power reduction amount to each color light source.

### BRIEF DESCRIPTION OF THE DRAWINGS

The above and other features and advantages of the invention will become more apparent by describing in detail embodiments thereof with reference to the attached drawings, in which:

FIG. 1 is a block diagram showing the configuration of an image display device according to an embodiment of the invention;

FIG. 2 is a graph showing an example of a histogram corresponding to a predetermined image;

FIG. 3 is a diagram showing an example where an input image is classified into six representative models;

FIG. 4 is a diagram showing an example where brightness is improved in an RGB space;

FIGS. 5 to 7 are graphs showing a power characteristic of each light source;

FIG. 8 is a table showing an experiment result of a luminance reduction rate of a light source according to a type of an input image when power of each light source is controlled by the image display device shown in FIG. 1;

FIG. 9 is a table showing an experiment result of a power reduction rate according to the type of the input image;

FIG. 10 is a flowchart showing the operation of the image display device according to the embodiment of the invention shown in FIG. 1; and

FIG. 11 is a block diagram showing the configuration of an image display device according to another embodiment of the invention.

### DESCRIPTION OF THE EMBODIMENTS

Advantages and features of the invention and methods of accomplishing the same may be understood more readily by reference to the following detailed description of embodiments and the accompanying drawings.

The invention may, however, be embodied in many different forms and should not be construed as being limited to the embodiments set forth herein. Rather, these embodiments are provided so that this disclosure will be thorough and complete and will fully convey the concept of the invention to those skilled in the art, and the invention will only be defined by the appended claims. Like reference numerals refer to like elements throughout the specification.

Hereinafter, an image display device and an image display method that support a power control of a multicolor light source according to embodiments of the invention will be described with reference to the accompanying drawings.

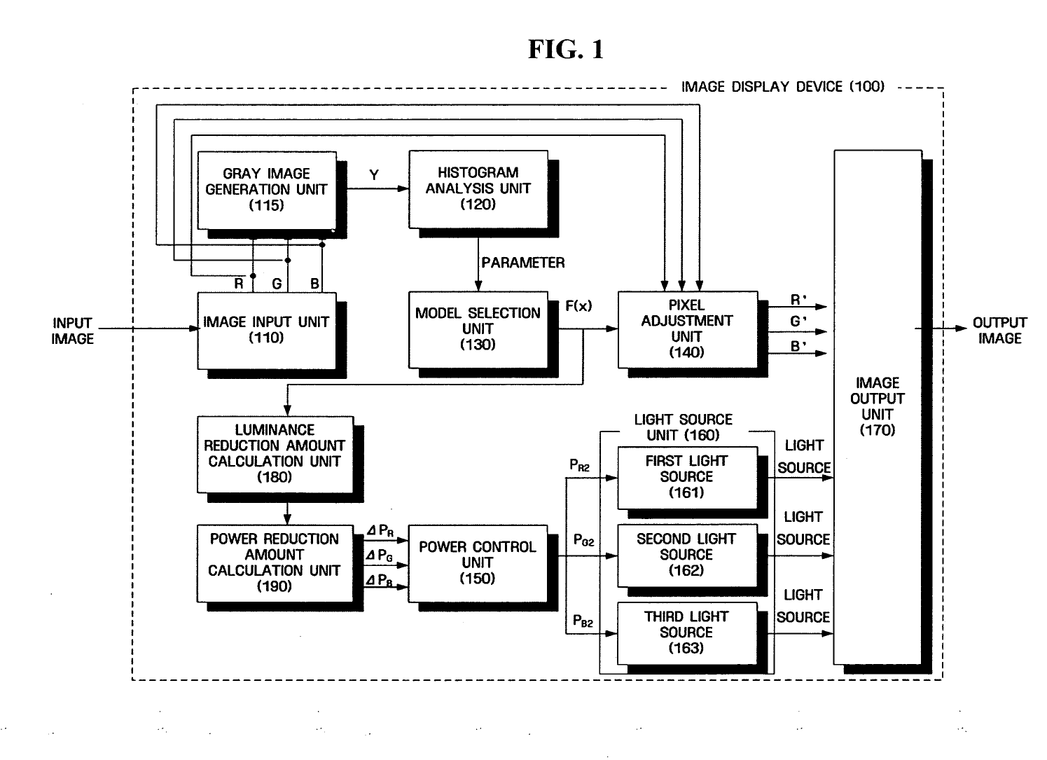

The image display device according to the embodiments of the invention uses a multicolor light source so as to display an image. Hereinafter, a case where a red light source, a green light source, and a blue light source are used will be exemplarily described. The image display device 100 improves brightness and contrast of an image using a desired method suitable for a characteristic of the input image. Further, the image display device 100 controls power to be supplied to each light source according to the characteristic of the input image so as to reduce power consumption with no distortion of the image. The image display device will be described in detail with reference to FIG. 1.

FIG. 1 is a block diagram showing the configuration of the image display device 100 according to an embodiment of the invention. As shown in FIG. 1, the image display device 100 includes an image input unit 110, a histogram analysis unit 120, a model selection unit 130, a pixel adjustment unit 140, a luminance reduction amount calculation unit 180, a power reduction amount calculation unit 190, a light source unit 160, and an image output unit 170.

The image input unit 110 receives an image (still picture or moving picture) from a predetermined image source and outputs sub-pixels, such as R, G, and B components, which form the input image. Here, the input image may have a signal of RGB format or a signal of different format, such as YCbCr or the like. If the input image has a different signal format including a grayscale signal Y, the image input unit 110 may include a gray image generation unit 115.

The gray image generation unit 115 generates a gray scale image on the basis of R, G, and B signals output from the image input unit 110. There are various methods of generating the grayscale signal Y on the basis of the R, G, and B signals. For example, the grayscale signal Y may be generated by multiplying each of the R, G, and B signals by ⅓ and then adding the results. Alternatively, an Equation based on NTSC standard, such as Equation 1 or the like, may be used.

The histogram analysis unit 120 prepares a histogram on the basis of the grayscale signal Y output from the gray image generation unit 115 and calculates a parameter that can represent the histogram.

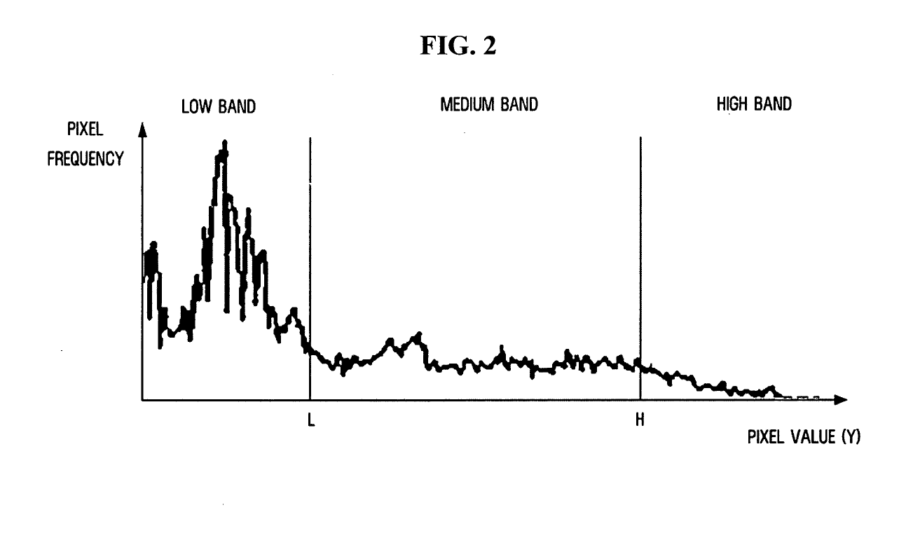

FIG. 2 shows an example of the histogram with respect to a certain image. The horizontal axis of the histogram indicates a brightness value of a pixel (hereinafter, referred to as “pixel value”) in the grayscale signal and has a value in a range of 0 to 255. The vertical axis of the histogram indicates a frequency with respect to each pixel value. The horizontal axis of the histogram is divided into a low band, a medium band, and a high band. A boundary L between the low band and the medium band indicates a pixel value, for example, corresponding to the lower-level 25% of the histogram. A boundary H between the medium band and the high band indicates a pixel value, for example, corresponding to the higher-level 25% of the histogram.

Parameters that represent the histogram may include, for example, HighSUM, MiddleSUM, LowSUM, Mean, Dynamic Range of the histogram, ZeroBin Count, and the like. HighSUM indicates the total number of pixels in the high band, MiddleSUM indicates the total number of pixels in the medium band, LowSUM indicates the total number of pixels in the low band, and Mean indicates an average of the pixel values with respect to the entire image. Further, ZeroBin Count indicates the number of pixels having a value equal to or less than 10% of the average pixel value among the pixels in the medium band.

Returning to FIG. 1, the histogram analysis unit 120 calculates the parameters on the basis of the histogram and supplies the calculation result to the model selection unit 130.

The model selection unit 130 analyzes the parameters, selects a representative model to which the input image corresponds among a predetermined number of representative models, and selects and supplies a brightness adjustment function F(x) corresponding to the selected representative model to the pixel adjustment unit 140.

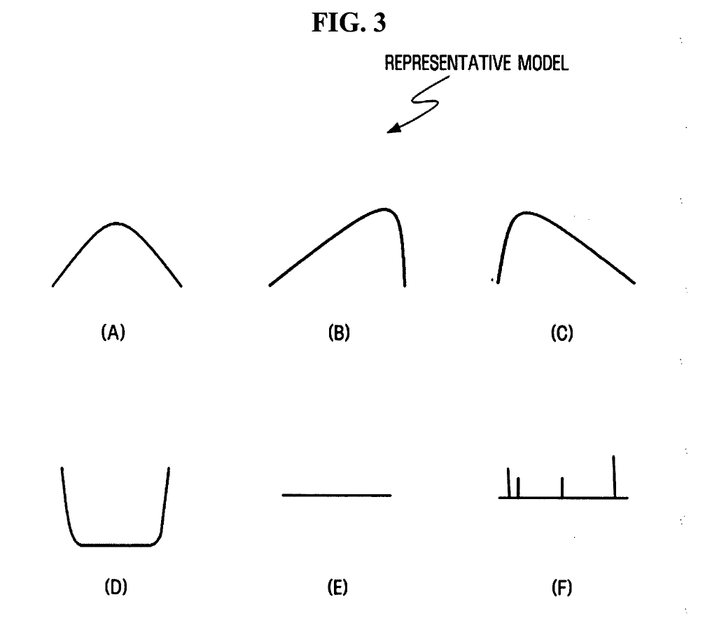

FIG. 3 shows an example where the input image is classified into six representative models. Here, a model A represents an image in which a lot of pixels are located in the medium band and few pixels are located in the high and low bands. A model B represents an image in which a lot of pixels are located in the high band and few pixels are located in the low and medium bands. That is, the model B represents a bright image. A model C represents an image in which a lot of pixels are located in the low band and few pixels are located in the middle and high bands. That is, the model C represents a dark image. A model D represents an image in which a lot of pixels are located in the low and high bands. That is, the model D represents a high-contrast image. A model E represents an image having even pixel value distribution. A model F represents an image having a lot of discontinuous pixel values, such as an image generated by a graphic operation. These six models are classified on the basis of the gray image histogram. However, the number of classifications and the formats of the modes may be subdivided or simplified depending on the parameter.

Each of the parameters is classified to one model among the models shown in FIG. 3 by a model classification algorithm. As an example of the classification algorithm, there may be a method of classifying the parameters by comparing each parameter with a predetermined threshold value.

In particular, when a histogram of an input image is analyzed, if the number of pixels included in the high band, that is, HighSUM is included in a threshold ratio (for example, 25%) with respect to the number of the entire pixels, the number of pixels included in the low band, that is, LowSUM is included in the threshold ratio, and Mean is included in a middle value range of a brightness range (hereinafter, referred to as “pixel range”) with respect to the entire image, the input image may be classified as the A type model. At this time, the pixel range indicates the number of grayscales displayed by one pixel. For example, in case of an 8-bit image, the pixel range becomes 0 to 255.

When the histogram of the input image is analyzed, if HighSUM is larger than the threshold ratio, LowSUM is included in the threshold ratio, and Mean is in a pixel range of 0.45 to 0.55, the input image may be classified as a B type model.

Meanwhile, if HighSUM is included in the threshold ratio, LowSUM is larger than the threshold ratio, and Mean is in the pixel range of 0.45 to 0.55, the input image may be classified as a C type model.

Further, if both HighSUM and LowSUM are larger than the threshold ratio and the sum of HighSUM and LowSUM is less than 125% of MiddleSUM, the input image may be classified as a D type model.

If both HighSUM and LowSUM are included in the threshold ratio, the sum of HighSUM and LowSUM is larger than 125% of MiddleSUM, and ZeroBin is larger than 50% of MiddleSUM, the input image may be classified as an F type model.

If both HighSUM and LowSUM are included in the threshold ratio, the sum of HighSUM and LowSUM is larger than 125% of MiddleSUM, and ZeroBin is less than 50% of MiddleSUM, the input image may be classified as an E type model.

Although the image models and the selection reference thereof according to the embodiment of the invention has been described, these are just examples and other image models may be selected.

Meanwhile, if the same size gains are applied to the entire pixel values so as to increase brightness of the input image, it is difficult to expect a high quality output image. That's because, there is an image in which quality can be good by only increasing entire brightness while there is an image in which quality can be good by adjusting both brightness and contrast according to a person's perceptual characteristic. Hereinafter, brightness of the image described in this specification means the average of brightness values of pixels in the image.

In order to adjust brightness of the image, brightness adjustment functions matched with the individual image models, that is, six functions are required. Each of the brightness adjustment functions matched with each of the image models has an “S” curve, but a specified form may be changed. The brightness adjustment function shows a desired pattern for increasing brightness for each model and informs how much brightness of each pixel in the input image should be increased. The horizontal axis (independent variable) of the brightness adjustment function indicates the pixel value and the vertical axis (subordinate variable) indicates a brightness increase ratio.

In order to find a brightness adjustment function for a predetermined model, it is necessary to execute an experimental process. That is, a plurality of brightness adjustment functions expected to be adaptable to the predetermined model should be prepared, each of the brightness adjustment functions are applied to the predetermined model (brightness is increased by a value corresponding to the function per pixel), and the most natural image is selected by a plurality of observers. Thereafter, the brightness adjustment function that indicates the selection result is matched with the predetermined model. If these processes are executed with respect to the plurality of models, the brightness adjustment function that is matched with each of the models can be acquired.

Returning to FIG. 1, the model selection unit 130 supplies the brightness adjustment function (F(x)) that is matched with the model selected with respect to the input image to the pixel adjustment unit 140.

The pixel adjustment unit 140 selects a representative signal among the RGB signals supplied from the image input unit 110. Here, the representative signal indicates a signal having the largest pixel value among the RGB signals. Therefore, the representative signal Yin may be represented by Equation 2.

Yᵢₙ=MAX(R, G, B) [Equation 2]

If the representative signal Yᵢₙ is substituted for the function F(x) supplied from the model selection unit 130 and a predetermined gain K is multiplied, the brightness amount F(Yᵢₙ)*K to be increased is determined by the pixel adjustment unit 140. The pixel adjustment unit 140 mixes the representative signal and the determined brightness amount, such that the output signal Yout of the representative signal Yin can be calculated by the following Equation 3. The gain K may be selected in a range of, for example, 0 to 2.

Yₒᵤₜ=Yᵢₙ+F(Yᵢₙ)*K [Equation 3]

Thereafter, the pixel adjustment unit 140 determines an increase rate C on the basis of a ratio of Yₒᵤₜ to Yᵢₙ by the following Equation 4.

C=Yₒᵤₜ/Yᵢₙ [Equation 4]

The pixel adjustment unit 140 adjusts each of the R, G, and B input signals R, G, and B to be increased by the increase rate C determined using Equation 4. The adjusted R, G, and B signals R′, G′, and B′ may be represented by the following Equation 5.

R′=R*C

G′=G*C

B′=B*C [Equation 5]

A signal having the largest pixel value is selected as the representative signal Yᵢₙ from among the R, G, and B signals so as to prevent the pixel value from exceeding the maximum displayable range of the R, G, and B elements due to the increase of the pixel value. Further, the reason why the same increase rate C is applied to each of the R, G, and B components is to prevent the color from being distorted.

In a case that an input color space is not the RGB color space, a value of the increase rate C of Equation 4 may be adjusted so as to prevent the color sense from being distorted in the corresponding input color space. An application method to each color signal is the same as Equation 5.

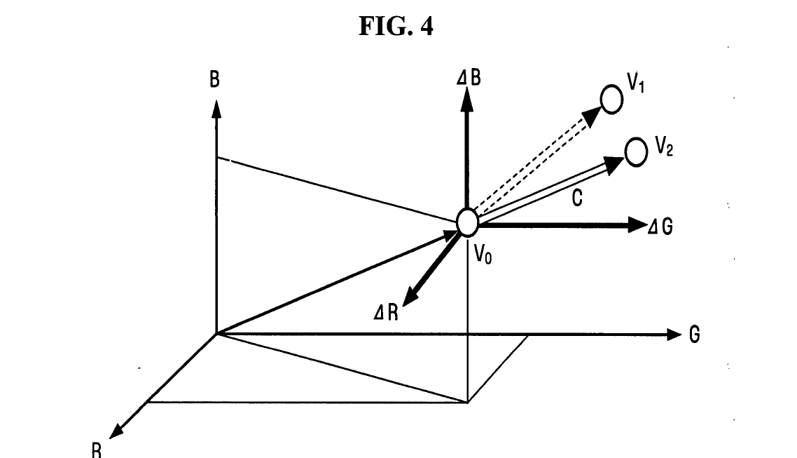

Specifically, referring to the RGB space shown in FIG. 4, if brightness of V₀ increases in a direction not consistent with the direction of a vector going toward V₀ from the origin (V₁), brightness increases. However, distortion occurs between V₀ and V₁ in the color sense. However, when the same increase rate C is multiplied to each of the R, G, and B components at V₀ so as to be consistent with the direction of the vector (V₂), brightness is improved and distortion does not occur. As described above, brightness and contrast of the image can be improved using a method suitable for the input image characteristic.

Returning to FIG. 1, the luminance reduction amount calculation unit 180 calculates the luminance reduction amount of each of the color light sources necessary to calculate the power reduction amount of each of the color light sources 161, 162, and 163 so as to be suitable for the input image characteristics. To this end, the luminance reduction amount calculation unit 180 finds a maximum luminance reduction amount with respect to the input image with reference to a look-up table that shows maximum luminance reduction amount information for each image model. Here, the maximum luminance reduction amount information for each image model can be acquired by executing an experimental process. That is, a brightness increase function corresponding to an image included in the predetermined model is applied to the image, and then the image to which the brightness increase function is applied is compared with an original image, thereby finding the luminance reduction amount that has the same brightness as the level of the original image. Table 1 exemplarily shows the maximum luminance reduction amount with respect to five image models acquired by the above-described experiment.

TABLE 1

| Image Model | Maximum luminance reduction amount |
|---|---|
| (A) | 50% |
| (B) | 10% |
| (C) | 50% |
| (D) | 15% |
| (E) | 25% |

Referring to Table 1, in case of the image model A, it can be understood that luminance can be reduced to 50% to the maximum. That is, in case of an image included in the A type model, even though luminance of the image is reduced to 50%, the same brightness as that of the original image can be acquired. In the same manner, in case of the image model B, it can be understood that luminance can be reduced to 10% to the maximum. That is, in case of an image included in the B type model, even though luminance of the image is reduced to 10%, the same brightness as that of the original image can be acquired.

With reference to the look-up table, such as Table 1, after the maximum luminance reduction amount corresponding to the input image is determined, the luminance reduction amount calculation unit 180 multiplies the determined maximum luminance reduction amount to the maximum luminance value of each of the color light sources so as to calculate the change value in luminance for each color light source. Here, the maximum luminance value of each of the color light sources can be acquired by measuring the luminance of each light source when power consumption of each light source has the maximum value. For specified explanation, an example where the maximum luminance reduction amount for each image model is the same as that of Table 1 and the A type image is input will be described. At this time, it is assumed that the maximum luminance value of the red light source is L_{RW}, the maximum luminance value of the green light source is L_{GW}, and the maximum luminance value of the blue light source is L_{BW} (unit: cd/m²). Then, the change values in luminance for the light sources by colors become 0.5 L_{RW}, 0.5 L_{GW}, and 0.5 L_{BW} (unit: cd/m2) by multiplying the maximum luminance reduction amount 50% of the input image to the maximum luminance value of the individual color light sources.

Thereafter, the luminance reduction amount calculation unit 180 calculates the luminance reduction amount of the corresponding light source on the basis of a difference between the maximum luminance value of a predetermined light source and a changed luminance value of the corresponding light source. That is, the luminance reduction amount calculation unit 180 calculates the luminance reduction amount L_{RW}−0.5 L_{RW} of the red light source on the basis of a difference between the maximum luminance value L_{RW} of the red light source and a changed luminance value 0.5 L_{RW} of the red light source. In the same manner, the luminance reduction amount calculation unit 180 calculates the luminance reduction amount L_{GW}−0.5 L_{GW} of the green light source and the luminance reduction amount L_{BW}−0.5 L_{BW} of the blue light source.

Meanwhile, when calculating the change values in luminance for the light sources by colors, only the maximum luminance reduction amount of the corresponding image model may be referred to. In this case, when images having maximum luminance reduction amounts different from each other are sequentially input, a phenomenon in which the image flickers, that is, flickering may occur. In order to prevent this flickering phenomenon, the luminance reduction amount calculation unit 180 can store a previous image frame. Further, the luminance reduction amount calculation unit 180 can calculate the luminance value to be changed of each of the color light sources with respect to a current image frame by multiplying an average of the maximum luminance reduction amount of the stored previous image frame and the maximum luminance reduction amount of the current image frame to the maximum luminance value of each of the color light sources. For example, it is assumed that stored two previous image frames correspond to the A type image model and D type image model, respectively, and a current image frame corresponds to the E type image model. The luminance reduction amount calculation unit 180 calculates an average luminance reduction amount between the maximum luminance reduction amount of the previous image frames and the maximum luminance reduction amount of the current image frame. Thereafter, the luminance reduction amount calculation unit 180 multiplies the average luminance reduction amount 30% to the maximum luminance value of each of the color light sources so as to calculate the luminance values 0.3 L_{RW}, 0.3 L_{GW}, and 0.3 L_{BW} (unit: cd/m²) to be changed of each of the color light sources.

The power reduction amount calculation unit 190 calculates a power reduction amount with respect to a predetermined light source on the basis of a difference between a power value corresponding to the maximum luminance value of the predetermined light source and a power value corresponding to the change values in luminance for the light sources by colors. Further, the power reduction amount calculation unit 190 controls power to be supplied to the corresponding light source of the light source unit 160 on the basis of the calculated power reduction amount.

In order to calculate the power reduction amount with respect to each of the color light sources, the power reduction amount calculation unit 190 should recognize a power characteristic with respect to each of the color light sources. Here, the power characteristic indicates the relationship between power consumption of a predetermined light source and a luminance value.

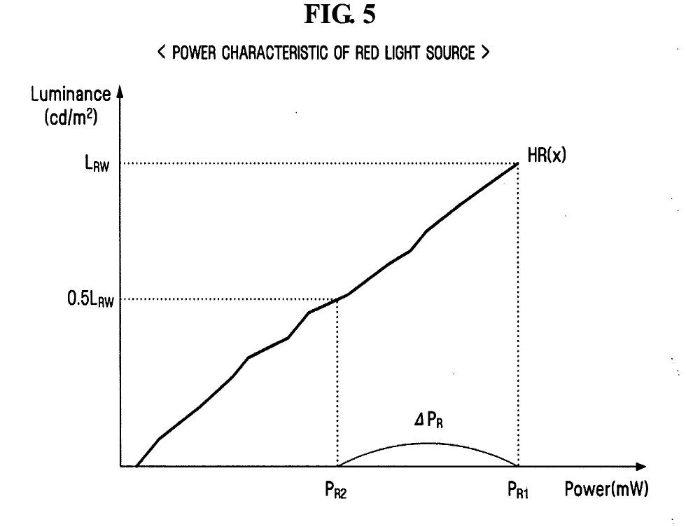

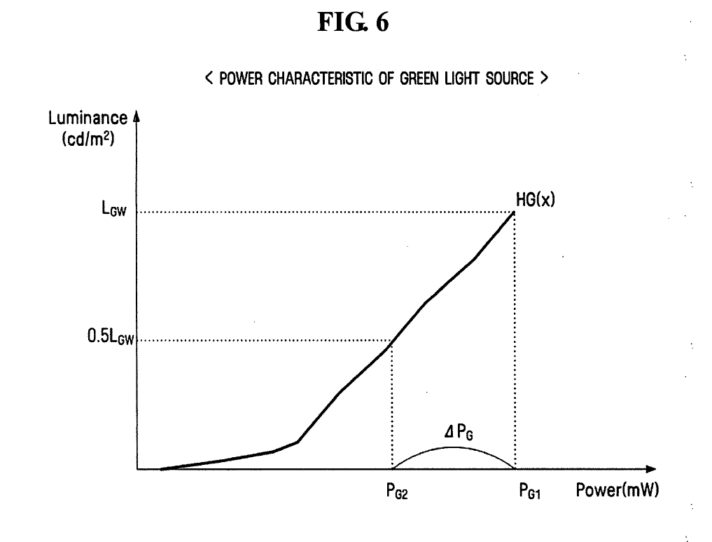

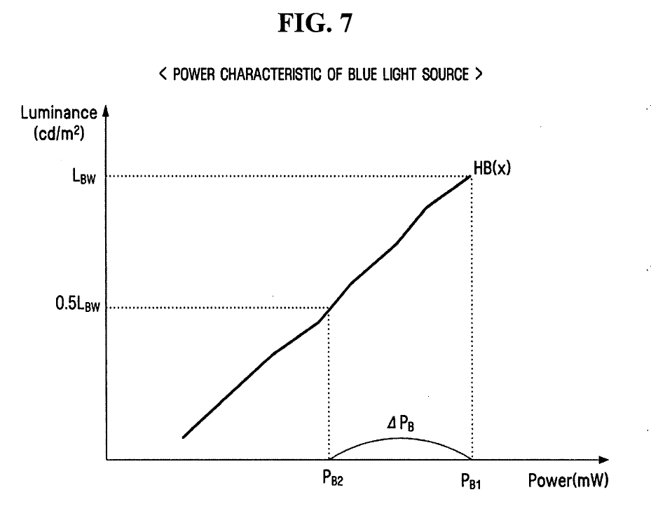

FIGS. 5 to 7 are graphs showing an example of the power characteristic of each of the color light sources. In particular, FIG. 5 is a graph showing an example of the power characteristic of the red light source, FIG. 6 is a graph showing an example of the power characteristic of the green light source, and FIG. 7 is a graph showing an example of the power characteristic of the blue light source.

In the power characteristic graphs shown in FIGS. 5 to 7, the horizontal axis indicates the strength of power P (unit: mW) and the vertical axis indicates the magnitude of luminance L (unit: cd/m²). In the power characteristic graph of each of the color light sources, the relationship between power P and luminance L is determined by a power characteristic function HR(x), HG(x), or HB(x). In the power characteristic graphs shown in FIGS. 5 to 7, it can be understood that the value of L increases as the value of P increases. The power characteristic graph of each of the color light sources can be acquired by executing an experimental process. That is, the power characteristic graph with respect to each of the color light sources can be acquired by applying power to a predetermined light source within a controllable range and measuring a luminance value of the corresponding light source.

Returning to FIG. 1, the power reduction amount calculation unit 190 calculates the power reduction amount of each color light source with respect to the input image. First, the power reduction amount calculation unit 190 calculates a power value P_{R1}, P_{G1}, or P_{B1} corresponding to the maximum luminance value of each color light source with reference to a power characteristic graph for each color light source. Here, the power values P_{R1}, P_{G1}, and P_{B1} may be defined by the following Equation 6.

P_{R1}=HR⁻¹(L_{RW})

P_{G1}=HG⁻¹(L_{GW})

P_{B1}=HB⁻¹(L_{BW}) [Equation 6]

Next, the power reduction amount calculation unit 190 calculates a power value corresponding to the change values in luminance for the light sources by colors with reference to the power characteristic graph for each color light source. That is, the power reduction amount calculation unit 190 acquires the change values in power values P_{R2}, P_{G2}, and P_{B2} for the light sources by colors. Here, the power values P_{R2}, P_{G2}, and P_{B2} may be defined by the following Equation 7.

P_{R2}=H−1(0.5 L_{RW})

P_{G2}=H−1(0.5 L_{GW})

P_{B2}=H−1(0.5 L_{BW}) [Equation 7]

Thereafter, the power reduction amount calculation unit 190 calculates the power reduction amount with respect to the predetermined light source on the basis of a difference between the power value corresponding to the maximum luminance value of the predetermined light source and the change values in power value for the predetermined light source. For example, the power reduction amount calculation unit 190 calculates the power reduction amount ΔP_{R} with respect to the red light source on the basis of a difference between the power value P_{R1} corresponding to the maximum luminance value L_{RW} of the red light source and the power value P_{R2} corresponding to the luminance value 0.3 L_{RW} to be changed. In the same manner, the power reduction amount calculation unit 190 calculates the power reduction amount ΔP_{G} with respect to the green light source and the power reduction amount ΔP_{B} with respect to the blue light source. The power reduction amount with respect to each color light source is supplied to the power control unit.

Next, the power control unit 150 reduces power to be supplied to the corresponding light source by the power reduction amount of the predetermined light source supplied from the power reduction amount calculation unit 190. For example, the power control unit 150 reduces power to be supplied to the red light source by ΔP_{R} and reduces power to be supplied to the green light source by ΔP_{G}. Further, the power control unit 150 reduces power to be supplied to the blue light source by ΔP_{B}.

The light sources 161, 162, and 163 having corresponding color components of the light source unit 160 supply light components corresponding to reduced power P_{R2}, P_{G2}, and P_{B2} to the image output unit 170.

The image output unit 170 generates a physical image on the basis of signals R′, G′, and B′ output from the pixel adjustment unit 140 and displays the generated physical image to a user. The image output unit 170 may be implemented by a plurality of display devices, such as an LCD, PDP, LED, OLED, or Flexible display.

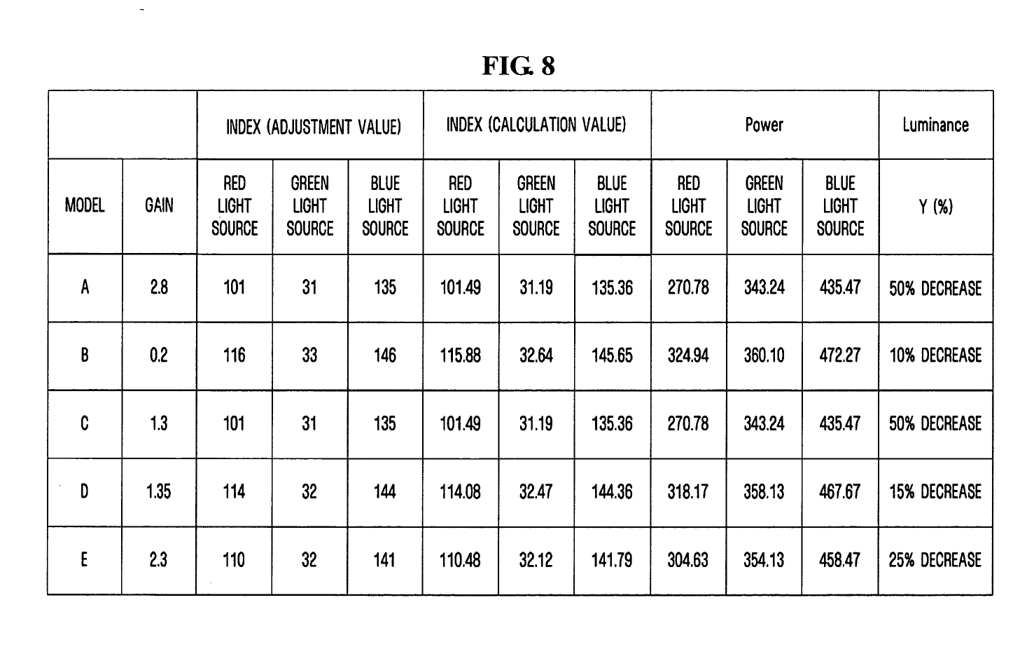

FIG. 8 shows an experiment result with respect to the luminance reduction amount according to a type of an input image when power of each color light source is controlled by the image display device 100 shown in FIG. 1

Referring to FIG. 8, it is assumed that power of each of the color light sources is controlled on the basis of an adjustment value of each of the color light sources. In case of the A type image model, 50% of luminance decreases. In case of the B type image model, 10% of luminance decreases.

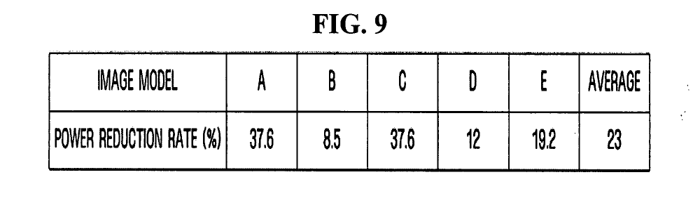

FIG. 9 shows a power reduction rate calculated according to the type of an image on the basis of the experiment of FIG. 8. At this time, the power reduction rate may be calculated by considering an operation range of each of the color light sources, like Equation 8.

100×(maximum power−power for minimum operation)/(reduced power−power for minimum operation) [Equation 8]

In Equation 8, maximum power indicates power when the light source ideally operates, and minimum power indicates power when light starts to be emitted from the light source.

When the power reduction rate according to the type of an image is calculated on the basis of Equation 8, in case of an image included in the A type image model, 37.6% of power may be reduced. In case of an image included in the B type image model, 8.5% of power may be reduced.

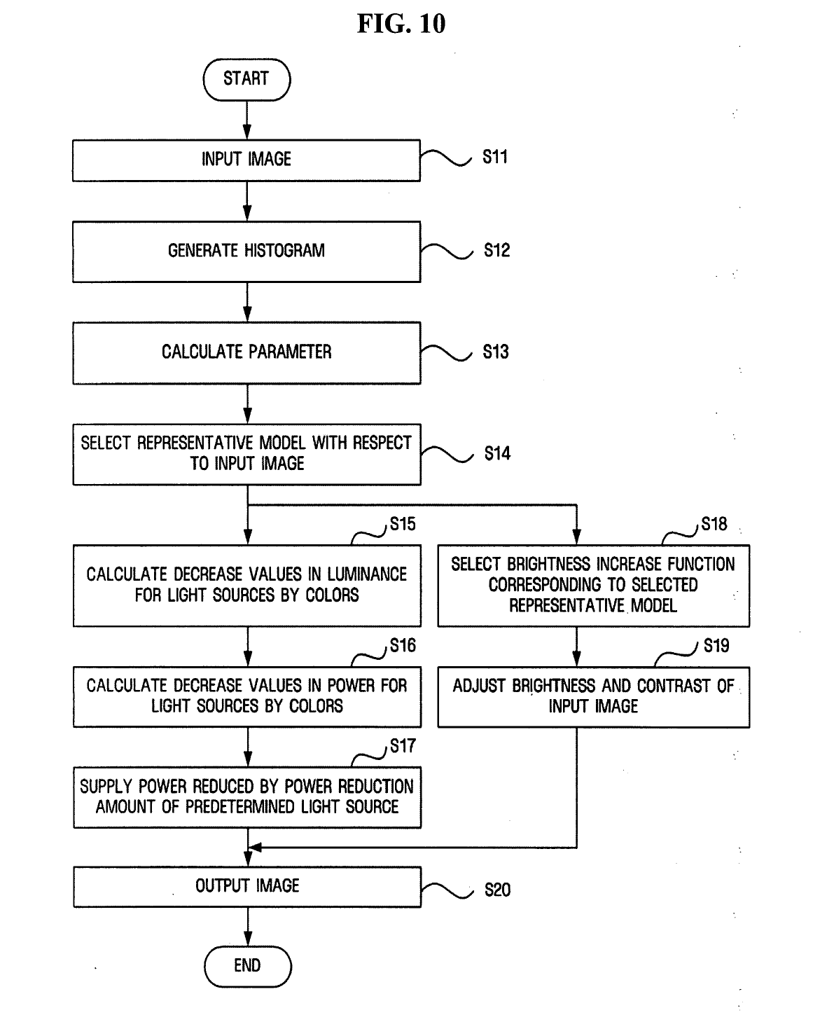

Next, the operation of the image display device 100 shown in FIG. 1 will be described with reference to FIG. 10.

First, the image input unit 110 receives an input image (Step S11).

Next, the histogram analysis unit 120 generates a histogram on the basis of a grayscale pixel value with respect to the input image (Step S12), and calculates a parameter capable of representing the input image on the basis of the histogram (Step S13). The histogram is represented on the basis of a frequency of the grayscale pixel value that is the average of R, G, and B components included in the input image.

The model selection unit 130 analyzes the parameter so as to select a model including the input image among a plurality of representative models (Step S14), and selects a brightness adjustment function matched with the selected model (Step S15). The parameter includes at least one of the number of pixels HighSUM included in a high band, the number of pixels LowSUM included in a low band, the number of pixels included in a medium band MiddleSUM, the average of the pixel values Mean with respect to the input image, the number of pixels ZeroBin having a value equal to or less than a predetermined ratio of a frequency average with respect to pixels included in the medium band, and a dynamic range of the histogram.

When a model including the corresponding input image is selected (Step S14), the luminance reduction amount calculation unit 180 calculates a luminance reduction amount of each of the color light sources (Step S15). At Step S15, a maximum luminance reduction rate corresponding to an input image is searched with reference to a look-up table including information of a maximum luminance reduction rate according to the model of the input image, an average luminance reduction rate with respect to the input image is calculated on the basis of the searched maximum luminance reduction rate and the maximum luminance reduction rate corresponding to a previous image, and a luminance value to be reduced of each color light source is determined by multiplying the maximum luminance value of each light source by the calculated average luminance reduction rate.

Next, the power reduction amount calculation unit 190 calculates the power reduction amount of each color light source with respect to each color light source with reference to a power characteristic graph (Step S16). At Step S16, power corresponding to a maximum luminance value of a predetermined light source is calculated, power corresponding to a luminance value to be changed is calculated, and a power reduction amount of the corresponding light source is calculated on the basis of a difference between the two power values.

The power control unit 150 supplies power reduced by the power reduction amount with respect to a predetermined light source to the corresponding light source (Step S17). For example, the power control unit 150 supplies power reduced by the power reduction amount with respect to the red light source to the red light source 161.

The color light sources 161, 162, and 163 of the light source unit 160 are respectively driven by power P_{R2}, P_{G2}, and P_{B2} reduced by the power reduction amount. The image output unit 170 displays an output image on the basis of light supplied by the individual color light sources 161, 162, and 163 (Step S20).

Meanwhile, when the model selection unit 130 selects a model including the input image (Step S14), the pixel adjustment unit 140 uses the brightness adjustment function corresponding to the selected model (Step S18) and adjusts the magnitude of each component included in the input image (Step S19). Here, an independent variable of the brightness adjustment function indicates a luminance value of a corresponding pixel, that is, the pixel value. Further, a dependent variable indicates a brightness increase rate with respect to the pixel value.

In step S16, the largest component among components included in the pixel included in the input image is selected, a predetermined gain K is multiplied to a result F(Yᵢₙ) in which the selected component Yᵢₙ is substituted in the brightness adjustment function and the multiplied result is added to the selected component Yᵢₙ, a ratio C between the added result Yₒᵤₜ and the selected component Yᵢₙ is acquired, and the size of each component included in the pixel included in the input image is increased by the ratio C.

The image output unit 170 displays an output image including pixels in which the magnitude is adjusted according to the components (Step S17).

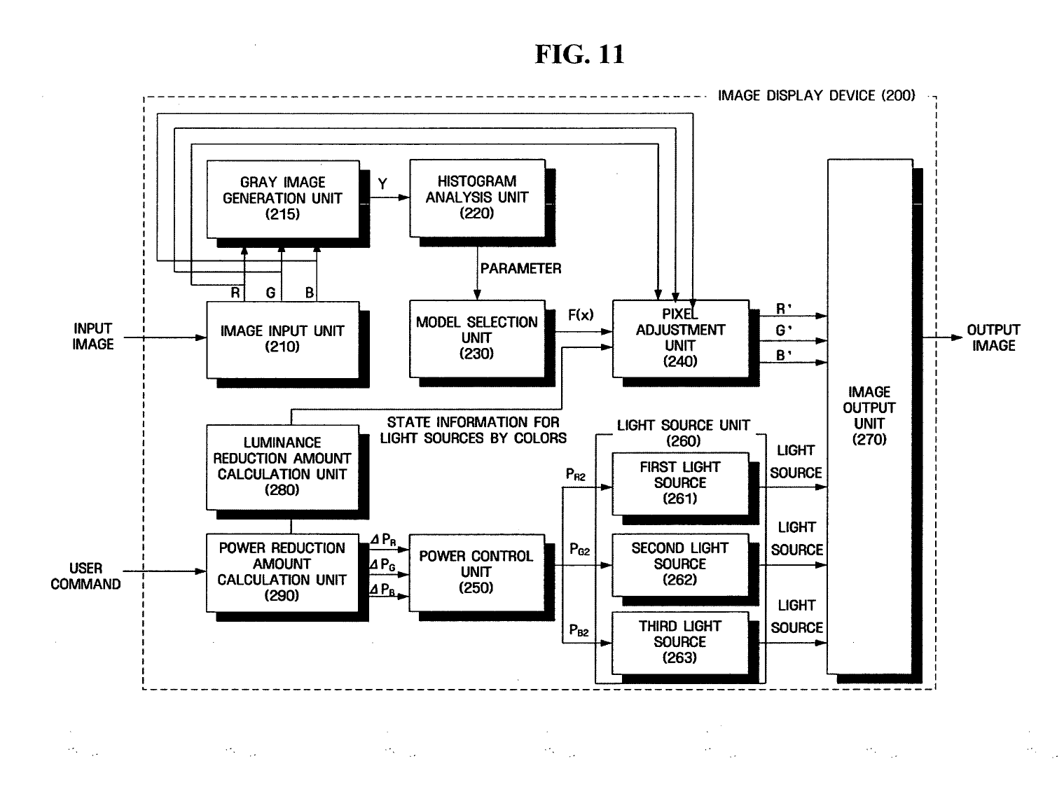

As described above, the image display device 100 reduces power to be supplied to each color light source on the basis of the characteristic of the input image. Hereinafter, an image display device 200 will be described with reference to FIG. 11. The image display device 200 reduces power according to a user command and compensates brightness of an image that becomes dark due to reduced power.

In FIG. 11, the operations of an image input unit 210, a gray image generation unit 215, a histogram analysis unit 220, a model selection unit 230, a pixel adjustment unit 240, a light source unit 260, and an image output unit 270 are the same as those shown in FIG. 1, and thus the descriptions thereof will be omitted. The operations of a power reduction amount calculation unit 290, a luminance reduction amount calculation unit 280, and a pixel adjustment unit 240 will be described.

First, the power reduction amount calculation unit 290 receives a desired power value input by a user. Then, the power reduction amount calculation unit 290 calculates a power reduction amount ΔP of each of the color light sources on the basis of a difference between current power P₁ and power P₂ input by the user and supplies the calculated power reduction amount ΔP of each of the color light sources to the power control unit 250. The power control unit 250 reduces current power P₁ with respect to predetermined light sources 261, 262, and 263 by the power reduction amount ΔP supplied from the power reduction amount calculation unit 290. Each of the light sources 261, 262, and 263 supplies light changed by reduced power P₂ to the image output unit 170.

The luminance reduction amount calculation unit 280 calculates a luminance reduction amount ΔL of each of the light sources 261, 262, and 263 on the basis of a difference between a luminance value corresponding to current power P₁ and a luminance value corresponding to power P₂ input by the user, and supplies the calculated luminance reduction amount ΔL to the pixel adjustment unit 240.

The pixel adjustment unit 240 outputs an image signal in which brightness and contrast are improved on the basis of the luminance reduction amount supplied from the luminance reduction amount calculation unit 280.

The image output unit 270 displays a physical image on the basis of R′, G′, and B′ signals output from the pixel adjustment unit 240 using light on the basis of the reduced power.

Although an image display device for supporting power control of light sources and a method of the same according to the embodiments of the invention has been described in connection with the exemplary embodiments of the invention, it will be apparent to those skilled in the art that various modifications and changes may be made thereto without departing from the scope and spirit of the invention. Therefore, it should be understood that the above embodiments are not limitative, but illustrative in all aspects.

The image display device and method that support a power control of a multicolor light source according to the embodiments of the invention have the following effects.

Since contrast and brightness of an input image increase on the basis of a type of the input image instead of reducing a power to be supplied to each of the color light sources, it is possible to reduce power consumption of a display module with no degradation of visibility of the image.

What is claimed is:

1. An image display method comprising:
calculating a parameter representative of an input image on the basis of a histogram with respect to the input image;
analyzing the parameter and selecting a representative model including the input image among a plurality of representative models;
calculating a luminance reduction amount for each color light source of the input image on the basis of a maximum luminance reduction rate;
calculating a power reduction amount for each color light source on the basis of the luminance reduction amount on the basis of power characteristic of each color light source; and
supplying power reduced by the power reduction amount to each color light source.

2. The image display method of claim 1, wherein the parameter comprises the number of pixels included in a high band, the number of pixels included in a low band, the number of pixels included in a medium band, and an average of pixel values with respect to the input image.

3. The image display method of claim 2, wherein the plurality of models comprises:
a model representative of an image in which a lot of pixels are comparatively located in the medium band;
a model representative of an image in which a lot of pixels are comparatively located in the high band;
a model representative of an image in which a lot of pixels are comparatively located in the low band; and
a model representative of an image in which a few of pixels are comparatively located in the medium band.

4. The image display method of claim 1, wherein the calculating of the power reduction amount of each color light source comprises:
calculating a first power value corresponding to a maximum luminance value of a predetermined light source;
calculating a second power value corresponding to a luminance value in which a predetermined value is multiplied to the maximum luminance value of the predetermined light source; and
calculating a power reduction amount of the predetermined light source on the basis of a difference between the first power value and the second power value.

5. The image display method of claim 1, wherein the predetermined value multiplied to the maximum luminance value of the predetermined light source is one of the maximum luminance reduction rate or an average luminance reduction rate that is a medium value between a maximum luminance reduction rate of a previous image frame stored in advance and a maximum luminance reduction rate of the input image frame.

6. The image display method of claim 1 further comprising:
selecting a brightness adjustment function corresponding to the selected representative model;
adjusting a brightness of a pixel included in the input image on the basis of the selected brightness adjustment function; and
displaying an output image including the pixels in which brightness is adjusted.

7. The image display method of claim 6, wherein the brightness adjustment function is represented by an ‘S’ curve that indicates a brightness increase rate of the corresponding pixel according to the brightness of the pixel.

8. The image display method of claim 1, wherein the histogram represents a frequency of a pixel having predetermined brightness.

9. The image display method of claim 1, wherein the power characteristic indicates luminance of the light source according to power consumption.

10. The image display method of claim 1 further comprising adjusting the brightness of the input image on the basis of a power reduction amount selected by a user.

11. An image display device comprising:
a histogram analysis unit calculating a parameter representative of an input image on the basis of a histogram of the input image;
a model selection unit analyzing the parameter and selecting a representative model including the input image among a plurality of representative models;
a luminance reduction amount calculation unit calculating a luminance reduction amount for each color light source of the input image on the basis of a maximum luminance reduction rate corresponding to the selected model;
a power reduction amount calculation unit calculating a power reduction amount for each color light source according to the luminance reduction amount on the basis of a power characteristic of each color light source; and
a power control unit supplying power reduced by the power reduction amount to each color light source.

12. The image display device of claim 11, wherein the parameter comprises the number of pixels included in a high band, the number of pixels included in a low band, the number of pixels included in a medium band, and an average of pixel values with respect to the input image.

13. The image display device of claim 11, wherein the plurality of models comprises:
a model representative of an image in which a lot of pixels are comparatively located in the medium band;
a model representative of an image in which a lot of pixels are comparatively located in the high ban;
a model representative of an image in which a lot of pixels are comparatively located in the low band; and
a model representative of an image in which a few of pixels are comparatively located in the medium band.

14. The image display device of claim 11, wherein the power reduction amount calculation unit calculates the power reduction amount for each light source on the basis of a difference between a first power value corresponding to a maximum luminance value of a predetermined light source and a second power value corresponding to a luminance value in which a predetermined value is multiplied to the maximum luminance value of a predetermined light source.

15. The image display device of claim 14, wherein the predetermined value multiplied to the maximum luminance value of the predetermined light source is one of the maximum luminance reduction rate or an average luminance reduction rate that is a medium value between a maximum luminance reduction rate of a previous image frame stored in advance and a maximum luminance reduction rate of the input image frame.

16. The image display device of claim 11 further comprising:
a pixel adjustment unit adjusting brightness of pixels included in the input image on the basis of a brightness adjustment function corresponding to the selected model; and
an image output unit displaying an output image including pixels in which brightness is adjusted.

17. The image display device of claim 16, wherein the brightness adjustment function is represented by an ‘S’ curve that indicates a brightness increase rate corresponding to the pixel according to brightness of the pixel.

18. The image display device of claim 11, wherein the histogram represents a frequency of a pixel having predetermined brightness.

19. The image display device of claim 11, wherein the power characteristic indicates luminance of the light source according to power consumption.

20. The image display device of claim 11, wherein:
the power reduction amount calculation unit calculates a power reduction amount according to a user command; and
the pixel adjustment unit increases brightness of the input image according to the calculated power reduction amount.
